(19) United States
(12) Patent Application Publication
(10) Pub. No.: US 2013/0014903 A1
(43) Pub. Date: Jan. 17, 2013

(54) APPLICATOR

(71) Applicant: Bryan T. Johnson, Vadnais Heights, MN (US)

(72) Inventor: Bryan T. Johnson, Vadnais Heights, MN (US)

(73) Assignee: Innovative Tools & Technologies, Inc., Saint Paul, MN (US)

(21) Appl. No.: 13/540,203

(22) Filed: Jul. 2, 2012

Related U.S. Application Data
(60) Provisional application No. 61/508,272, filed on Jul. 15, 2011.

(51) Int. Cl. B32B 37/12

(52) U.S. Cl. 156/538

(57) ABSTRACT

An applicator for use in the application of, for example, adhesive-backed material from a roll to a surface may be configured to hold the roll of adhesive-backed material and to apply the adhesive-backed material from the roll to the surface using two rollers.

### CROSS-REFERENCE TO RELATED APPLICATION

This application claims the benefit of U.S. Provisional Application Ser. No. 61/508,272, filed 15 Jul. 2011, entitled “APPLICATOR,” which is incorporated herein by reference in its entirety.

### BACKGROUND

The disclosure herein relates generally to an applicator for holding a roll of material, e.g., adhesively-backed material used to cover, or line, the walls of a spray booth.

Spray booths are often used to provide working conditions (e.g., temperature, air flow, humidity, etc.) for painting objects such as, e.g., body panels of a car. Particulate matter (e.g., dust, dirt, over-sprayed paint or powder, etc.) may contaminate spray booths.

Various materials may be used to cover, or line, the walls of a spray booth to trap particulate matter within the booth. For example, 3M DIRT TRAP material is adhesive-backed material that may be applied to the walls of a spray booth to trap particulate matter.

### SUMMARY

The disclosure herein relates generally to an applicator for holding a roll of material used to trap particulate matter and applying the material to a surface, e.g., a wall, floor, ceiling, etc. The applicator may include a stand and material holding apparatus movably connected to the stand portion. The material holding apparatus may be movable upwardly and downwardly along the stand portion, and may be configured to apply the material to a surface. For example, the material holding apparatus may present at least a portion of the material in a substantially planar configuration and a user may move the material holding apparatus towards the surface such that the substantially planar surface of the portion of the material contacts and adheres to the surface. The user may then move the applicator along the wall in a direction parallel to the surface. As the user moves the applicator along the surface, the material may un-roll, or un-spool, from the roll of material, may follow a delivery path within the framework of the material holding apparatus, and may be applied to the surface.

One exemplary applicator disclosed herein for use in the application of adhesive-backed material from a roll of adhesive-backed material to a wall surface may include a base portion movable over a ground surface, an upright member extending from a bottom portion to a top portion along an upright member vertical axis (e.g., wherein the bottom portion of the upright member is coupled to the base portion), and material holding apparatus movable to one or more positions along the upright member vertical axis. The material holding apparatus may include a frame adjustably coupled to the upright member for movement of the material holding apparatus along the upright member vertical axis, roll holding apparatus coupled to the frame and configured to hold the roll of adhesive-backed material, a first roller coupled to the frame and configured to rotate about a first roller vertical axis, and a second roller coupled to the frame and configured to rotate about a second roller vertical axis (e.g., wherein the first roller and the second roller are configured to position a portion of the adhesive-backed material in a plane for application to a wall surface).

One or more embodiments of the applicator may include one or more of the following features: the material holding apparatus may be configured to apply the adhesive-backed material to a wall surface when the portion of the adhesive-backed material positioned in a plane is moved into contact with the wall surface the material holding apparatus is moved over the ground surface while the adhesive-backed material is maintained in contact with the wall surface to continuously apply the adhesive-backed material from the roll of adhesive-backed material to the wall surface; the roll holding apparatus may be configured to hold the roll of adhesive-backed material along a roll axis (e.g., wherein the roll axis is parallel to each of the first and the second roller vertical axes); the roll holding apparatus may be configured to hold the roll of adhesive-backed material such that the roll of adhesive-backed material is rotatable about the roll axis; the material holding apparatus may be configured to apply the adhesive-backed material to the wall surface by extending the adhesive-backed material from the roll to an outer surface of each of the first and the second rollers; the base portion may define a perimeter and include a base frame extending about at least a portion of the perimeter, a first horizontal wheel rotationally coupled to the base frame proximate a first corner of the perimeter to rotate about a first wheel vertical axis and, a second horizontal wheel rotationally coupled to the base frame proximate a second corner of the perimeter to rotate about a second wheel vertical axis (e.g., wherein the first and the second horizontal wheels and the first and the second rollers are configurable to contact a wall surface simultaneously); at least a portion of the circumference of each of the first and the second horizontal wheels and the first and the second rollers may define a plane when configured to contact a wall surface simultaneously; each of the first and the second rollers may include a resilient material (e.g., a foam material); the frame of the material holding apparatus may be rotationally coupled to the upright member for movement of the material holding apparatus about the upright member vertical axis; the material holding apparatus may be positionable in one or more positions along the upright member vertical axis; and/or the base portion may include a plurality of wheels configured to engage the ground surface and to allow the base portion to be moved over the ground surface.

Another exemplary applicator for use in the application of adhesive-backed material from a roll of adhesive-backed material to a surface may include a frame, roll holding apparatus coupled to the frame and configured to hold the roll of adhesive-backed material, a first roller coupled to the frame and configured to rotate about a first roller axis, and a second roller coupled to the frame and configured to rotate about a second roller axis (e.g., wherein the first roller and the second roller are configured to position a portion of the adhesive-backed material in a plane for application to a surface).

One or more embodiments of the applicator may include one or more of the following features: the frame, the first roller, and the second roller may be configured to apply the adhesive-backed material to a surface when the portion of the adhesive-backed material positioned in a plane is moved into contact with the surface and the frame is moved with respect to the surface while the adhesive-backed material is maintained in contact with the surface to continuously apply the adhesive-backed material from the roll of adhesive-backed material to the surface; the roll holding apparatus may be configured to hold the roll of adhesive-backed material along a roll axis (e.g., wherein the roll axis is parallel to each of the first and the second roller axes); the roll holding apparatus may be configured to hold the roll of adhesive-backed material such that the roll of adhesive-backed material rotatable about the roll axis; the frame, the first roller, and the second roller may be configured to apply the adhesive-backed material to the surface by extending the adhesive-backed material from the roll to an outer surface of each of the first and the second rollers; and each of the first and the second rollers may include resilient material (e.g., a foam).

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1A is a front perspective view of an exemplary applicator.

FIG. 1B is a front perspective view of the applicator of FIG. 1A holding material.

FIG. 2 is a rear perspective view of the applicator of FIG. 1A holding material.

FIG. 3A is a top view of the applicator of FIG. 1A.

FIG. 3B is a top view of the applicator of FIG. 1A holding material.

FIGS. 4A-C are side views of the applicator of FIG. 1A with the material holding apparatus located in various positions.

FIG. 5A is a front view of the applicator of FIG. 1A.

FIG. 5B is a front view of the applicator of FIG. 1A holding material.

FIG. 6 is a perspective view of an applicator configured to apply material to a ground surface.

FIG. 7 is a front perspective view of another exemplary applicator.

FIG. 8 is a rear perspective view of the applicator of FIG. 7.

FIG. 9 is a rear perspective view of another exemplary applicator.

### DETAILED DESCRIPTION OF EXEMPLARY EMBODIMENTS

In the following detailed description of illustrative embodiments, reference is made to the accompanying figures of the drawing which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

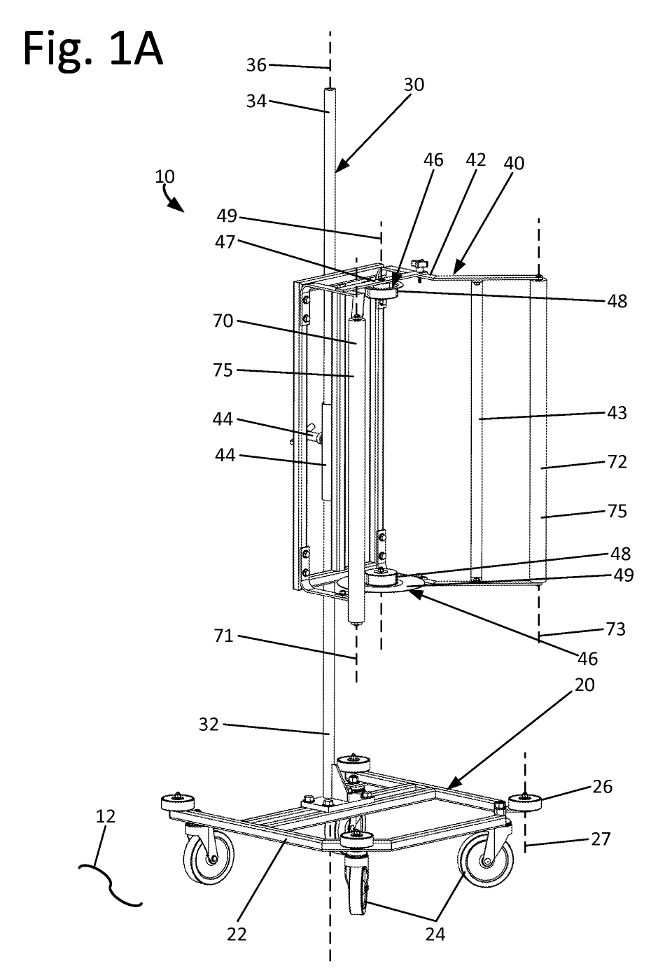

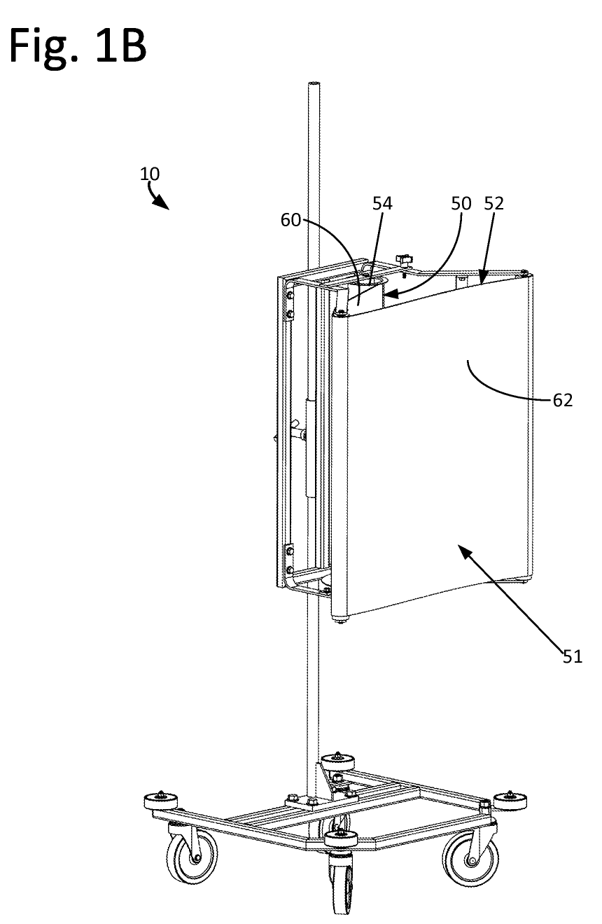

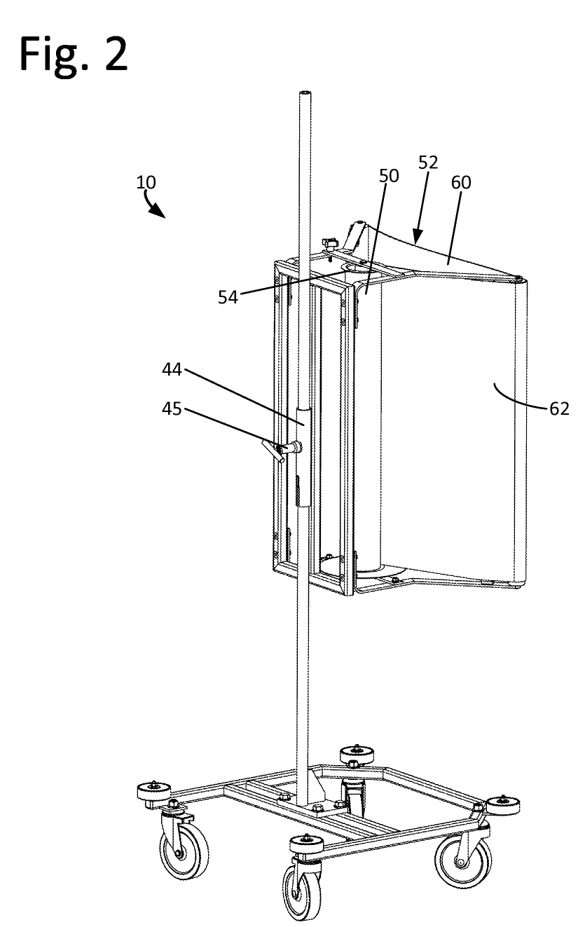

Exemplary apparatus shall be described with reference to FIGS. 1-9. It will be apparent to one skilled in the art that elements from one embodiment may be used in combination with elements of the other embodiments, and that the possible embodiments of such apparatus using combinations of features set forth herein is not limited to the specific embodiments shown in the Figures and/or described herein. Further, it will be recognized that the embodiments described herein may include many elements that are not necessarily shown to scale. Still further, it will be recognized that the size and shape of various elements herein may be modified but still fall within the scope of the present disclosure, although certain one or more shapes and/or sizes, or types of elements, may be advantageous over others.

An exemplary embodiment of an applicator 10 for use in the application of adhesive-backed material from a roll of adhesive-backed material to a wall surface is depicted in FIGS. 1-5. Generally, the applicator 10 includes a base portion 20, an upright member 30, and material holding apparatus 40, and is located on a ground surface 12.

The base portion 20 of the applicator 10 engages, or contacts, the ground surface 12 to support the applicator 10 above the ground surface 12. Further, the base portion 20 may enable movement of the applicator 10 across the ground surface 12. As shown, the base portion 20 includes a plurality (e.g., four) of wheels 22 connected (e.g., pivotally coupled) to a base frame 24.

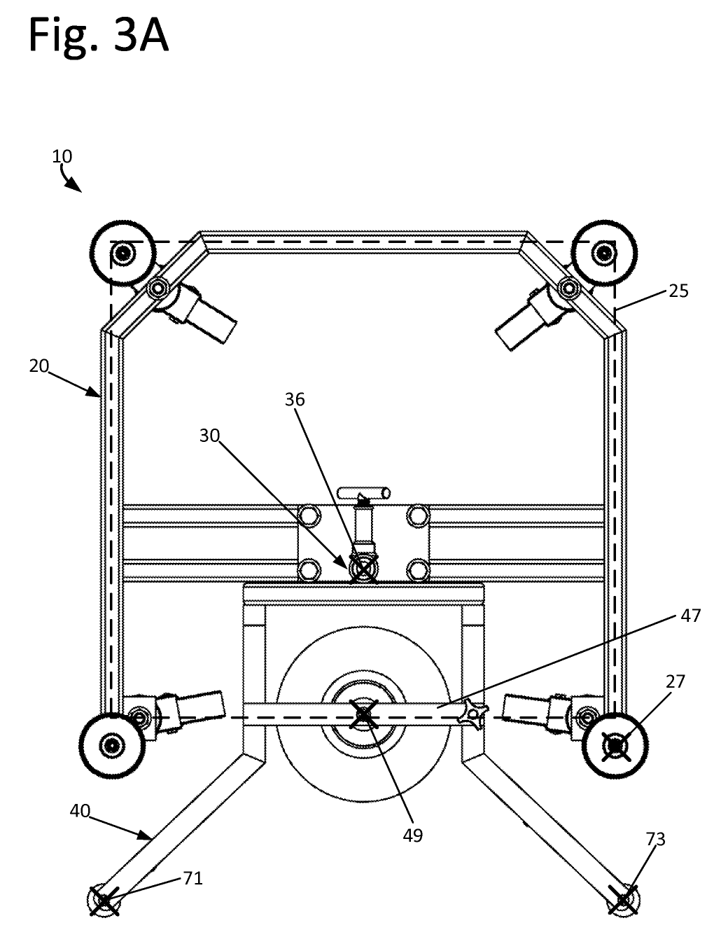

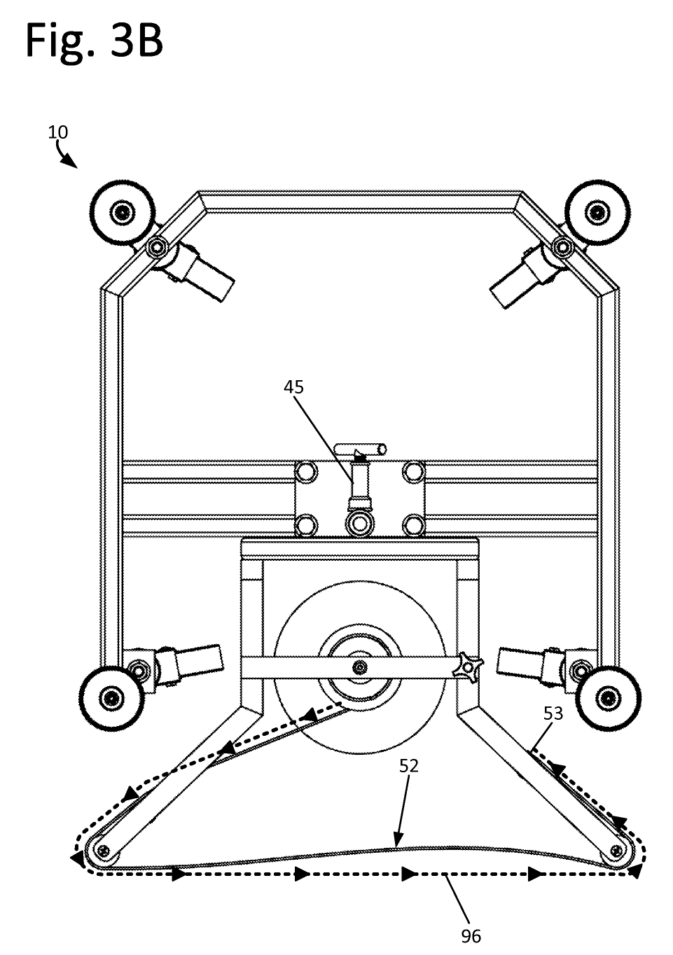

The base frame 24 may define a perimeter 25 around the base portion 20 of the applicator 10 (e.g., as shown in FIG. 3B). The base portion 20 may further include one or more horizontal wheels 26 coupled to the base frame 24 proximate at least one corner of the perimeter 25. The one or more horizontal wheels 26 may be used in conjunction with the material holding apparatus 40 to apply adhesive-backed material to a wall surface as will be described further herein. Each of the horizontal wheels 26 may be configured to rotate about a vertical axis 27 that may be substantially perpendicular to the ground surface 12.

The upright member 30 may extend from a bottom portion 32 to a top portion 34 along an upright member vertical axis 36. The bottom portion 32 of the upright member 30 may be coupled to the base portion 20 (e.g., the base frame 24). As shown, the bottom portion 32 of the upright member 30 is coupled to the base portion 20 in a generally central location of the base portion 20 using a bracket and a plurality of bolts. Although this embodiment uses bolts to couple the upright member 30 to the base portion 20, any coupling technique, e.g., such as welding, may be used to couple these two elements.

Further, the elements of the applicator 10 (e.g., the base portion 20, the upright member 30, the material holding apparatus 40, etc.) may be formed of any material (e.g., steel, aluminum, a polymer, etc.) as would be known by one having skill in the art. Further, such elements may be hollow, solid, circular, square, and/or any other shape, size, or configuration as would be known by one having skill in the art.

In one or more embodiments, the upright member 30 may define a length extending from the bottom portion 32 to the top portion 34 of about 3 feet to about 7 feet, or greater (e.g., 9 feet, 10 feet, 11 feet, 12 feet). As shown in FIGS. 1-5, the upright member 30 defines a hollow, circular cross section (e.g., a cylindrical shape).

The material holding apparatus 40 may be configured to hold the roll 50 of adhesive-backed material 52 in a manner that allows the material 52 to be applied to a wall surface. The adhesive-backed material 52 may define a front surface 60 and a back surface 62. The back surface 62 may include adhesive such that the back surface 62 may be applied to wall surfaces to present the front surface 60 facing outwardly from the wall surface to, e.g., trap particulate matter. In at least one embodiment, the adhesive-backed material 52 is 3M DIRT TRAP material.

Although the exemplary systems and apparatus are described herein with respect to the application of an adhesive-backed material, it is to be understood the exemplary systems and apparatus may be used in the application of any type of material to a surface. In at least one embodiment, the exemplary systems and apparatus may be used with material that lacks adhesive.

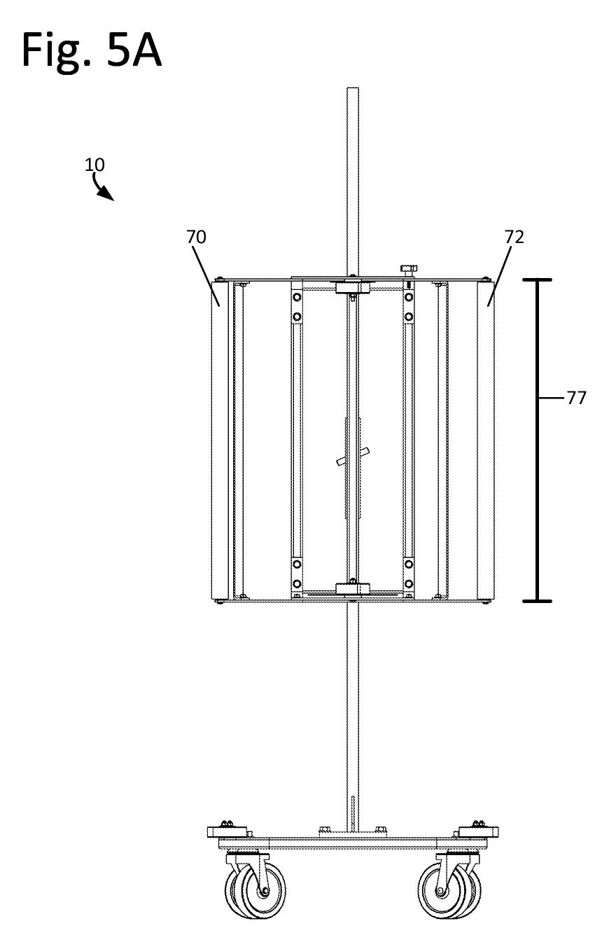

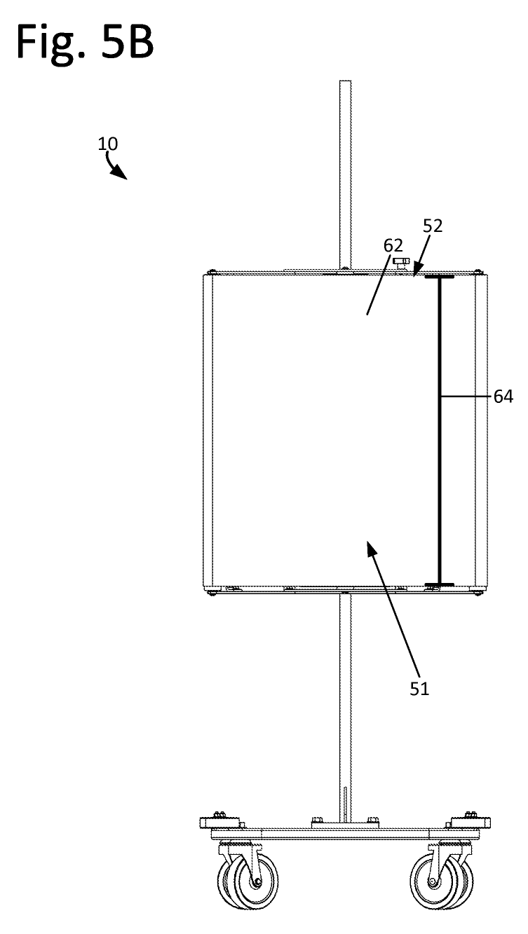

The roll 50 may further include a cylindrical core 54 upon which the material 52 is wrapped, or spooled, with the back surface 62, i.e., the surface including adhesive, facing inwardly (e.g., facing towards the core 54) and the front surface facing outwardly (e.g., facing away from the core 54). The adhesive-backed material 52 may further define a length and a height 64 (as shown in FIG. 5B). The adhesive-backed material 52 may be wrapped lengthwise about the core 54 to form the roll 50. The length of the material 52 may be any suitable length when unwrapped from the roll 50. In one or more embodiments, the height 64 may be about 20 inches to about 96 inches, although the material may be of any suitable height. In at least one embodiment, the length, for example, is 300 feet and the height 64 is 28 inches. In at least another embodiment, for example, the height 64 is 36 inches. In at least another embodiment, for example, the height 64 is 56 inches.

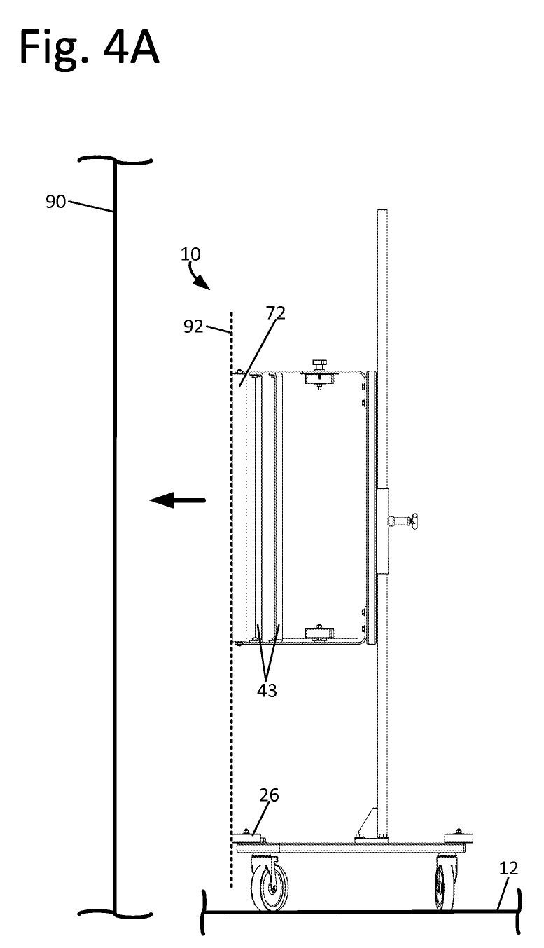

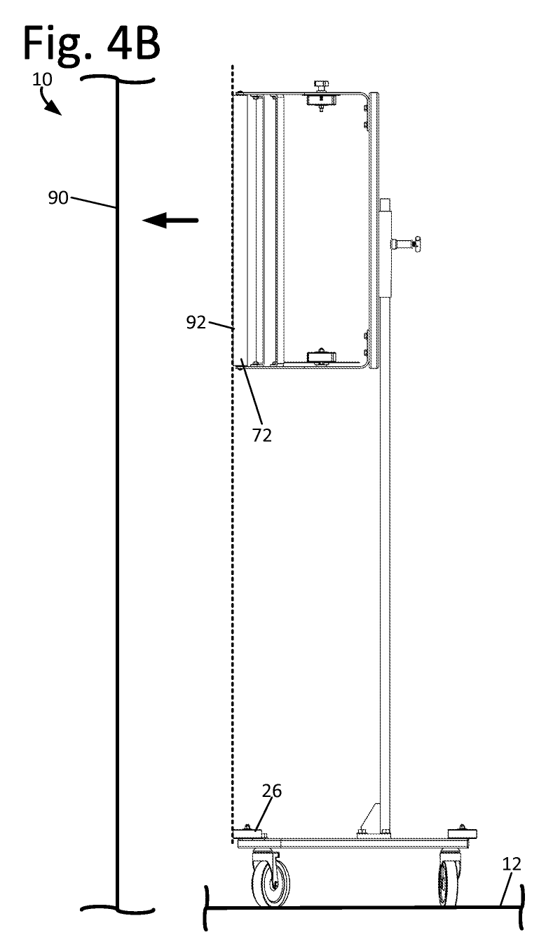

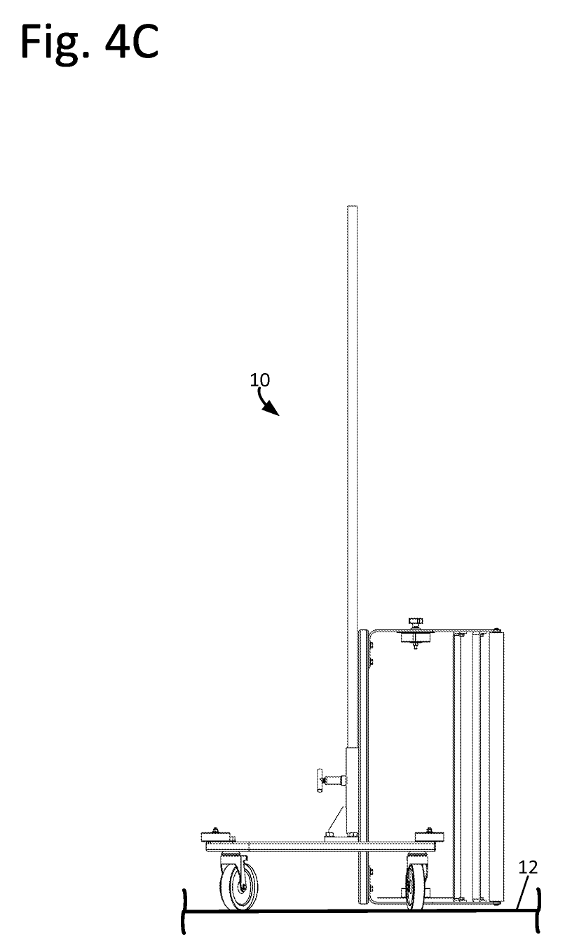

The material holding apparatus 40 may be configured to direct, or extend, the material 52 from the roll 50 to a position at which it may be applied to a wall surface 90 (as shown in FIGS. 4A-C). More specifically, the material holding apparatus 40 may be configured to apply the adhesive-backed material 52 to a wall surface by positioning a portion 51 of the adhesive-backed material 52 in a plane and maintaining the adhesive-backed material 52 in contact with the wall surface to continuously apply the adhesive-backed material 52 from the roll 50 of adhesive-backed material 52 to the wall surface 90.

For example, the applicator 10, and in turn the material holding apparatus 40, may be moved such the portion 51 of the adhesive-backed material 52 positioned in a plane is moved into contact with the wall surface 90. Due to the contact with the wall surface 90, the portion 51 of the adhesive-backed material 52 may adhere, or stick, to the wall surface 90. The applicator 10 may then be moved over the ground surface 12, e.g., in a direction parallel the wall surface 90, while force is applied to the applicator 10 to maintain the adhesive-backed material 52 in contact with the wall surface 90. As the applicator 10 moves, the adhesive-backed material 52 will be continuously unspooled, or unwrapped, from the roll 50 and be continuously applied (e.g., adhered, stuck, etc.) to the wall surface 90, even around corners.

Further, the material holding apparatus 40 may be movable to one or more positions along the upright member vertical axis 36 to, e.g., apply adhesive-backed material 52 to a wall surface 90 at various heights. For example, the material holding apparatus 40 is positioned in a middle position as shown in FIG. 4A, in an upper position as shown in FIG. 4B, and in a lower position as shown in FIG. 4C.

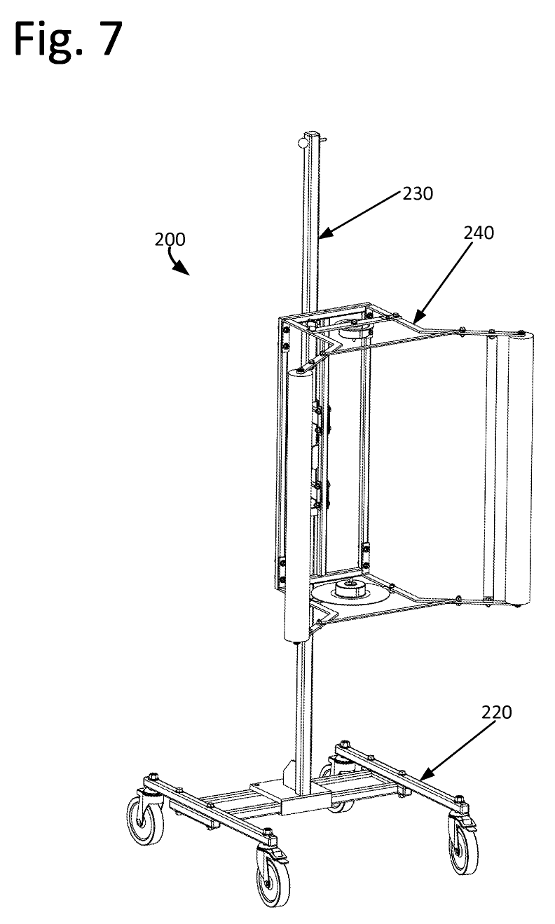

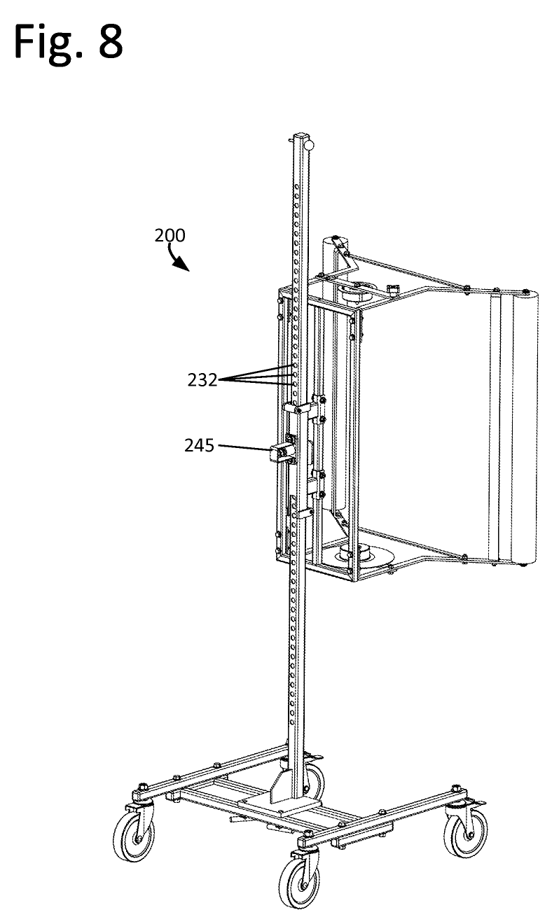

The material holding apparatus 40 may further be movable, or rotatable, about the upright member vertical axis 36 (e.g., rotatable around the upright member vertical axis). For example, the material holding apparatus 40 depicted in FIG. 4C has been rotated 180 degrees with respect to the remainder of the applicator 10 from where it was in FIG. 4A. In at least one embodiment, the rotation may allow the material holding apparatus 40 to reach the lowermost position depicted in FIG. 4C, e.g., to apply adhesive-backed material 52 to a lower portion of a wall surface 90. In at least another embodiment (e.g., the embodiment depicted in FIGS. 7-8), the applicator 20 may be configured such that the material holding apparatus 40 may not need to be rotated to reach the lowermost position as depicted in FIG. 4C.

In at least the embodiment depicted in FIGS. 1-5, the material holding apparatus 40 includes a frame 42, roll holding apparatus 46, a first roller 70, and a second roller 72. The frame 42 may be adjustably coupled to the upright member 30 for movement of the material holding apparatus 40 along the upright member vertical axis 36. As shown, the frame 42 may include a sleeve portion 44 that defines an aperture within which the upright member 30 may be located such that the frame 42 may move, or slide, upwardly and downwardly along the upright member 30.

The frame 42 may further include locking apparatus 45 that may hold the frame 42 in a fixed position relative to the upright member 30 (e.g., such that the material holding apparatus 40 may not move vertically or rotationally with respect to the upright member 30). In at least one embodiment, the locking apparatus 45 may include a handle that may be rotated to contact the upright member 30. In at least another embodiment, the locking apparatus 45 may include a “dead man” locking apparatus that includes a handle that automatically engages the upright member 30 (e.g., using a spring-biased pin that enters an aperture located on the upright member 30).

The roll holding apparatus 46, which may be coupled to the frame 42, is configured to hold a roll 50 of adhesive-backed material 52. To do so, the roll holding apparatus 46 may include a pair of cylindrical portions 48 that may enter the open ends of the cylindrical core 54 of the roll 50. Further, the lower cylindrical portion 48 may further include a plate or disc 59 that is configured to further hold the roll 50 (e.g., to keep the adhesive-backed material 52 on the roll 50 itself). As shown, the roll holding apparatus 46 may further include a pivotable portion 47 that may be moved to load a roll 50 into the roll holding apparatus 46.

The roll holding apparatus 46 is configured to allow the roll 50 to rotate about a roll axis 49 to distribute the material 52 from the roll 50. In the embodiment depicted, the roll axis 49 is substantially vertical (e.g., perpendicular to the ground surface 12, parallel to the wall surface 90, etc.). In other embodiments, the roll axis 49 may not be substantially vertical so long as it allows the material 52 to be distributed, or moved, to the first and second rollers 70, 72.

The first and second rollers 70, 72 are each coupled to the frame 42 and configured to position a portion 51 (as shown in FIG. 1B) of the adhesive-backed material 52 in a plane for application to a wall surface 90. For example, the adhesive-backed material 52 may be extended from the roll 50 to, and partially around, an outer surface of the first roller 70, and then to, and partially around, an outer surface of the second roller 72. Together, the first and second rollers 70, 72 align the portion 51 of the material 52 in a substantially planar configuration that may be substantially parallel to a wall surface 90 (e.g., that is perpendicular to the ground surface 12). In other words, the first and second rollers 70, 72 align the portion 51 of the material 52 in a configuration that is perpendicular to the ground surface 12. Further, in one or more embodiments, each of the rollers 70, 72 may have a height 77 (as shown in FIG. 5A) that is at least as long as the height 64 (as shown in FIG. 5B) of the adhesive-backed material 52.

The material holding apparatus 40 may be described as defining a material distribution pathway 96 (as shown in FIG. 3B) from the roll 50 to, and partially around, the first roller 70 and to, and partially around, the second roller 72. Further, frame 42 may further include guide members 43 located proximate each of the first and second rollers 70, 72. The guide members 43 may be located on the interior of the material distribution pathway 96 and may be used to guide the adhesive-backed material 52 to and around the rollers 70, 72. Further, one of the guide members 43 may be used to attach an end 53 of the adhesive-backed material 52 to stow the adhesive-backed material 52 when not in use. In other words, the end 53 of the adhesive-backed material 52 may be attached to a guide member 43 to stop the roll 50 of material 52 from unraveling or unspooling (as shown in FIG. 3B).

Although the material holding apparatus 40 described herein includes two rollers and two guides, it is to be understood the exemplary systems and/or apparatus may include any number of rollers and guides, e.g., to be used in the application of a material to a surface.

Further, the first roller 70 may be rotationally coupled to the frame 42 about a first roller axis 71 and the second roller 72 may also be rotationally coupled to the frame 42 about a second roller axis 73. The ability of the first and the second rollers 70, 72 to rotate freely may further assist in the movement and in the even distribution of the adhesive-backed material 52 from the roll 50 to the wall surface 90.

As depicted, the first roller axis 71 and the second roller axis 73 may be substantially parallel to each other and substantially perpendicular to the ground surface 12. In turn, the wall surface 90, upon which the adhesive-backed material 52 may be applied, may be perpendicular to the ground surface 12, and as such, the first roller axis 71 and the second roller axis 73 may be parallel to the wall surface 90.

As described herein, the height 64 of the adhesive-backed material 52 may be about 20 inches to about 96 inches. In one or more embodiments, the material holding apparatus 40 may be modifiable or adaptable to facilitate adhesive-backed material 52 of various heights 64. For example, the frame 42, the roll holding apparatus 46, the first roller 70, and the second roller 72, as well as any other part of the material holding apparatus 40, may be extended or shortened (e.g., in a direction parallel to the height 77 or roller axes 71, 73 of the rollers 70, 72) to accommodate shorter or taller rolls of adhesive-backed material 52, or alternatively, one or more substitute parts having extended or shortened dimensions may be used (e.g., rollers and/or guide members having a longer length may be used in a frame lengthened by extension apparatus).

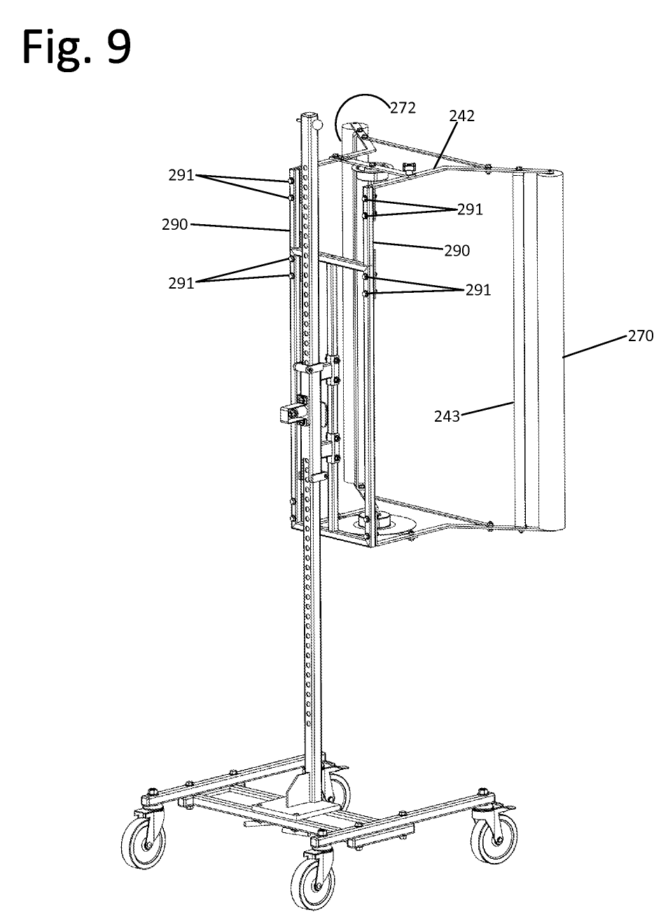

In at least one embodiment as shown in FIG. 9, extension apparatus designed for one or more parts of the material holding apparatus 200 (shown in FIG. 8) may be coupled to such parts, and/or substitute parts may be substituted for such one or more parts, to extend the height of the material holding apparatus 200 to accommodate taller rolls of adhesive-backed material. For example, as shown in FIG. 9, the frame 242 may include extension elements 290 (e.g., coupled at the top of the frame 242 with bolts 291) that increases the height of the frame 242 (e.g., taken parallel to axes of rollers 270, 272) from about 28 inches to about 36 inches (or to about 56 inches). Further, for example, with the frame 242 extended, a substitute first roller 270 and a substitute second roller 272 may be used to increase the height of the first and second rollers to about 36 inches (or to about 56 inches). Still further, for example, substitute guide members 243 may be used to increase the height of the guide members (e.g., taken parallel to the roller axes of the rollers 270, 272) from about 28 inches to about 36 inches (or to about 56 inches). Such guide members or rollers could be extended using extension elements instead of substitute parts.

Not all wall surfaces 90 and ground surfaces 12 are substantially perpendicular and/or uniform (e.g., free from irregularities, etc.). To address these issues among others, each of the first and second rollers 70, 72 may include resilient material 75. Resilient material 75 may be defined as material that is compressible under application of force from a normal state to a compressed state and that returns to the normal state when the force is removed. A “normal state” may be defined as the shape and volume of the resilient material 75 before any external forces are applied to it (except, e.g., natural forces that may include gravity, air pressure, etc.). In one or more embodiments, resilient material 75 may be compressible to a “compressed state” that occupies about 70% or less volume, about 60% or less volume, about 50% or less volume, about 40% or less volume, about 30% or less volume, or 20% or less volume, than occupied by the resilient material 75 in the normal state. In at least one embodiment, the resilient material 75 may be a closed cell material. However, open cell materials may also be used. Still further, for example, in at least one embodiment, nitrile rubber (NBR) foam may be used.

The resiliency, or compressibility, of the resilient material 75 of the first and second rollers 70, 72 may allow the rollers 70, 72 to be compressed against the wall surface 90 during application of the adhesive-backed material 52 to the wall surface 90. Further, the resiliency of the resilient material 75 of the first and second rollers 70, 72 may allow an even distribution of pressure across the entire height 64 of the material 52 to the wall surface 90 resulting in an even application of the material 52 to the wall surface 90. Still further, the resiliency of the resilient material 75 of the first and second rollers 70, 72 may allow the rollers 70, 72 to be compressed against the wall surface 90 to provide even application of the adhesive-backed material 52 to a wall surface 90 that contains irregularities (e.g., bumps, cracks, seams, etc.) and/or that is not perpendicular to the ground surface 12.

Further, as depicted, the roll axis 49 may be substantially parallel to the first roller axis 71 and the second roller axis 73, e.g., to allow even distribution of the adhesive-backed material 52 from the roll 50 to the first and second rollers 70, 72, to provide a planar portion 51 of the adhesive-backed material 52, etc.

Further, the rollers 70, 72 may be configured (e.g., positioned) such that they may be used to continuously apply adhesive-backed material 52 through corners. For example, a first wall surface may abut a second wall surface at a corner (e.g., a 90 degree corner, a 270 degree corner, etc.). The applicator 10 may be moved through the corner such that each of the rollers 70, 72 maintain contact with one of the first wall surface and the second wall surface. For example, when the applicator 10 is moving through a corner from a first wall surface to a second wall surface, a first roller may meet the corner first and may be transitioned from the first wall surface to the second wall surface while moving the applicator 10 through the corner. When the second roller reaches the corner, it also may be transitioned from the first wall surface to the second wall surface leaving continuously applied adhesive-backed material extending from the first wall surface, through the corner, and onto the second wall surface.

As described herein, the base portion 20 may include one or more horizontal wheels 26 that may be used in conjunction with the material holding apparatus 40 to apply adhesive-backed material to a wall surface. For example, the horizontal wheels 26 may be configured in conjunction with the first and second rollers 70, 72 to contact a wall surface simultaneously such that even pressure is applied vertically along each of the first and the second rollers 70, 72. Further, the horizontal wheels 26 may provide stability to the applicator 10 when the material holding apparatus 40 is located in an upper position as shown in FIG. 4B. In at least one embodiment, at least a portion of the circumference of each of the one or more horizontal wheels 26 and the first and second rollers 70, 72 defines a plane 92 when configured to contact a wall surface 90 simultaneously (as shown in FIGS. 4A-4B).

The material holding apparatus 40 (e.g., apart and/or removed from the applicator 10) may be used by itself to apply adhesive-backed material 52 to a surface (e.g., a ground surface or floor, a wall surface, a ceiling surface, etc.). In essence, the material holding apparatus 40 may be an “applicator,” and as such, may be called an “applicator” when described to be used without the remainder of the applicator 10.

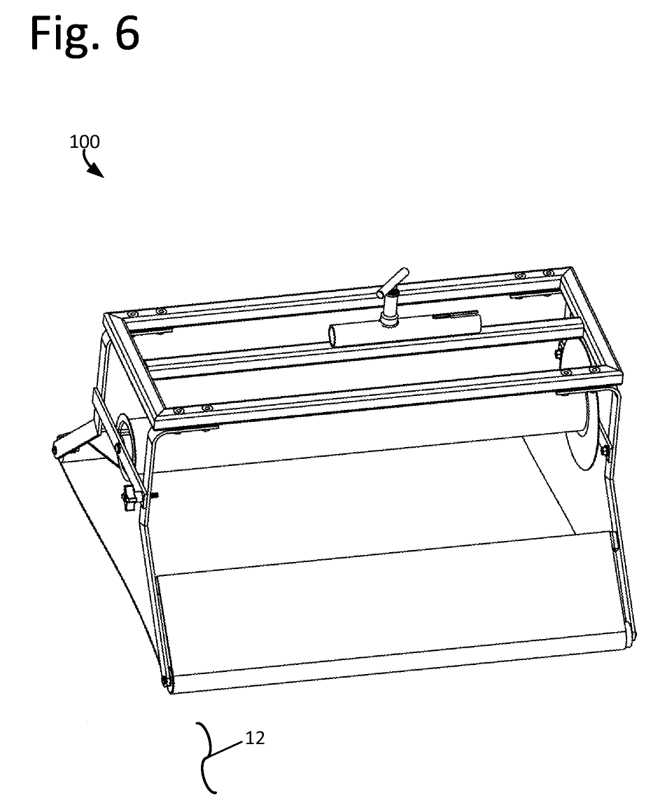

For example, applicator 100, which is the material holding apparatus 40 used without the base portion 20 and the upright member 30, may be used to apply a material, e.g., an adhesive-backed material, to a ground surface 12 (e.g., floor) as depicted in FIG. 6. Although the applicator 100 is shown applying adhesive-backed material to a ground surface 12, a technician may use the applicator 100 to apply adhesive-backed material to any surface such as, e.g., a ceiling surface, a slanted-wall surface, a wall surface, etc.

An additional embodiment of an applicator 200 is depicted in FIGS. 7-8. Applicator 200 may include many of the same apparatus and structures, and may be used in substantially the same way, as the applicator 10 described in reference to FIGS. 1-5. The applicator 200, however, includes a few differences from the applicator 10.

For example, the upright member 230 of the applicator 200 has a square tubular cross section. As a result, the material holding apparatus 240 of the applicator 100 may not be rotatable about an axis extending along the upright member 230.

Further, for example, the base portion 220 of the applicator 200 is shaped differently that the base portion 20 of the applicator 10. Due to this different shape, the base portion 220 of the applicator 200 may allow positioning of the material holding apparatus 240 in the lowermost position (e.g., as shown in FIG. 4C) without rotating the material holding apparatus 240 about an axis extending along the upright member 230.

Still further, for example, the material holding apparatus 240 may include a “dead man” locking apparatus 245 that includes a handle that automatically engages the upright member 230 (e.g., using a spring-biased pin that enters one of a plurality of apertures 232 located on the upright member 230).

The complete disclosure of the patents, patent documents, and publications cited herein are incorporated by reference in their entirety as if each were individually incorporated. Exemplary embodiments of the present disclosure are described above. Those skilled in the art will recognize that many embodiments are possible within the scope of the disclosure. Other variations, modifications, and combinations of the various components and methods described herein can certainly be made and still fall within the scope of the disclosure. Thus, the invention is limited only by the following claims and equivalents thereto.

What is claimed is:

1. An applicator for use in the application of adhesive-backed material from a roll of adhesive-backed material to a wall surface, the applicator comprising:
a base portion movable over a ground surface;
an upright member extending from a bottom portion to a top portion along an upright member vertical axis, wherein the bottom portion of the upright member is coupled to the base portion; and
material holding apparatus movable to one or more positions along the upright member vertical axis, wherein the material holding apparatus comprises:
a frame adjustably coupled to the upright member for movement of the material holding apparatus along the upright member vertical axis,
roll holding apparatus coupled to the frame and configured to hold the roll of adhesive-backed material,
a first roller coupled to the frame and configured to rotate about a first roller vertical axis, and
a second roller coupled to the frame and configured to rotate about a second roller vertical axis,
wherein the first roller and the second roller are configured to position a portion of the adhesive-backed material in a plane for application to a wall surface.

2. The applicator of claim 1, wherein the material holding apparatus is configured to apply the adhesive-backed material to a wall surface when the portion of the adhesive-backed material positioned in a plane is moved into contact with the wall surface and the material holding apparatus is moved over the ground surface while the adhesive-backed material is maintained in contact with the wall surface to continuously apply the adhesive-backed material from the roll of adhesive-backed material to the wall surface.

3. The applicator of claim 1, wherein the roll holding apparatus is configured to hold the roll of adhesive-backed material along a roll axis, wherein the roll axis is parallel to each of the first and the second roller vertical axes.

4. The applicator of claim 1, wherein the roll holding apparatus is further configured to hold the roll of adhesive-backed material such that the roll of adhesive-backed material is rotatable about the roll axis.

5. The applicator of claim 1, wherein the material holding apparatus is further configured to apply the adhesive-backed material to the wall surface by extending the adhesive-backed material from the roll to an outer surface of each of the first and the second rollers.

6. The applicator of claim 1, wherein the base portion defines a perimeter and comprises:
a base frame extending about at least a portion of the perimeter,
a first horizontal wheel rotationally coupled to the base frame proximate a first corner of the perimeter to rotate about a first wheel vertical axis and,
a second horizontal wheel rotationally coupled to the base frame proximate a second corner of the perimeter to rotate about a second wheel vertical axis,
wherein the first and the second horizontal wheels and the first and the second rollers are configurable to contact a wall surface simultaneously.

7. The applicator of claim 6, wherein at least a portion of the circumference of each of the first and the second horizontal wheels and the first and the second rollers defines a plane when configured to contact a wall surface simultaneously.

8. The applicator of claim 1, wherein each of the first and the second rollers comprises resilient material.

9. The applicator of claim 1, wherein the frame of the material holding apparatus is rotationally coupled to the upright member for movement of the material holding apparatus about the upright member vertical axis.

10. The applicator of claim 1, wherein the material holding apparatus is positionable in one or more positions along the upright member vertical axis.

11. The applicator of claim 1, wherein the base portion comprises a plurality of wheels configured to engage the ground surface and to allow the base portion to be moved over the ground surface.

12. An applicator for use in the application of adhesive-backed material from a roll of adhesive-backed material to a surface, the applicator comprising:
a frame;
roll holding apparatus coupled to the frame and configured to hold the roll of adhesive-backed material;
a first roller coupled to the frame and configured to rotate about a first roller axis; and
a second roller coupled to the frame and configured to rotate about a second roller axis,
wherein the first roller and the second roller are configured to position a portion of the adhesive-backed material in a plane for application to a surface.

13. The applicator of claim 12, wherein the frame, the first roller, and the second roller are configured to apply the adhesive-backed material to a surface when the portion of the adhesive-backed material positioned in a plane is moved into contact with the surface and the frame is moved with respect to the surface while the adhesive-backed material is maintained in contact with the surface to continuously apply the adhesive-backed material from the roll of adhesive-backed material to the surface.

14. The applicator of claim 12, wherein the roll holding apparatus is configured to hold the roll of adhesive-backed material along a roll axis, wherein the roll axis is parallel to each of the first and the second roller axes.

15. The applicator of claim 12, wherein the roll holding apparatus is further configured to hold the roll of adhesive-backed material such that the roll of adhesive-backed material rotatable about the roll axis.

16. The applicator of claim 12, wherein the frame, the first roller, and the second roller are further configured to apply the adhesive-backed material to the surface by extending the adhesive-backed material from the roll to an outer surface of each of the first and the second rollers.

17. The applicator of claim 12, wherein each of the first and the second rollers comprises resilient material.
